(19) United States
(12) Patent Application Publication
(10) Pub. No.: US 2017/0074768 A1
(43) Pub. Date: Mar. 16, 2017

(54) Common Radiation Path for Acquiring Particle Information by Means of Direct Image Evaluation and Differential Image Analysis

(71) Applicant: Anton Paar GmbH, Graz (AT)

(72) Inventors: Christian Moitzi, Raaba (AT); Gerhard Murer, Graz (AT); Norbert Reitinger, Graz (AT); Jelena Fischer, Graz (AT)

(21) Appl. No.: 15/125,418

(22) PCT Filed: Mar. 12, 2015
(86) PCT No.: PCT/EP2015/055172

§ 371 Date: Sep. 12, 2016

(30) Foreign Application Priority Data
Mar. 12, 2014 (AT) A50184/2014

(51) Int. Cl. G01N 15/02; G06T 7/60; G01N 15/14

(52) U.S. Cl. CPC G01N 15/0227; G01N 15/1463; G01N 15/1436; G06T 7/60; G01N 2015/144; G01N 2015/1497; G06T 2207/10004

(57) ABSTRACT

Device for determining information which is indicative for a particle size and/or a particle shape of particles in a sample, wherein the device comprises an electromagnetic radiation source for generating electromagnetic primary radiation, an electromagnetic radiation detector for detecting electromagnetic secondary radiation which is generated by an interaction of the electromagnetic primary radiation with the sample, and a determination unit which is adapted for determining the information which is indicative for the particle size and/or the particle shape based on the detected electromagnetic secondary radiation, wherein the determination unit is adapted for selectively determining the information firstly by means of an identification and a size determination and/or a shape determination of the particles on a detector image which is generated from the electromagnetic secondary radiation, and/or for determining the information secondly from temporal changes of the electromagnetic secondary radiation between detector images which are generated at different detection points in time.

### CROSS-REFERENCE TO RELATED APPLICATIONS

This application is a U.S. national phase patent application of PCT/EP2015/055172, which claims the benefit of the filing date of Austrian Patent Application No. A50184/2014, filed Mar. 12, 2014, the disclosure of which is hereby incorporated herein by reference in its entirety.

### TECHNICAL FIELD

Embodiments of the invention relate to a device and a method for determining information which is indicative for a particle size and/or a particle shape of particles in a sample, a corresponding storage medium and a software-program. The invention further relates to a device and a method for determining information which is indicative for a zeta potential of particles in a sample, a corresponding storage medium and a software-program.

### TECHNOLOGICAL BACKGROUND

Dynamic image analysis (DIA) enables to analyze dispersions (suspensions, emulsions, aerosols) with respect to the particle size and the particle shape. The term particle, in the context of this application, also includes droplets as they are present in emulsions or aerosols, for example. Since DIA is an optical and an imaging method, the lower measuring limit (smallest particle size which can still be imaged) is limited by the physical resolution limit (ca. a half light wavelength when the objective has a correspondingly large numerical aperture). By means of DIA, it is further possible to determine the shape of the particles. In this manner, a meaningful size distribution can be calculated. Corresponding prior art is disclosed in EP 0,507,746, U.S. Pat. No. 3,641,320 and U.S. Pat. No. 6,061,130.

In the field of particle characterization, the measuring limit for the particle size in imaging measuring methods was conventionally lowered by a combination with “laser obscuration” (LOT, company Ankersmid—EyeTech) or nano-particle tracking (NTA, company NanoSight—NS300). Both technologies however have the disadvantage that single particles are measured and consequently the present particle concentration has to be very low. In addition, for a good statistic, a lot of particles have to be analyzed which in turn significantly extends the measuring time. Furthermore, LOT further has the disadvantage that the optical setup is not compatible with a typical DIA setup.

Another technology is described in “Differential Dynamic Microscopy: Probing Wave Vector Dependent Dynamics with a Microscope”, Roberto Cerbino, Veronique Trappe, Physical Review Letters 100, 188102 (2008) and “Scattering information obtained by optical microscopy: Differential dynamic microscopy and beyond”, Fabio Giavazzi, Doriano Brogioli, Veronique Trappe, Tommaso Bellini, Roberto Cerbino, Physical Review E 80, 031403 (2009). It is the so-called differential dynamic microscopy, referred to as DDM in the following. By means of DDM, it is possible to measure the size of particles in liquids (suspensions) by analyzing their proper motion (Brownian molecular motion). Since the Brownian molecular motion depends on the temperature, a constant temperature of the sample during the measurement is to be ensured.

Further prior art is disclosed in DE 10 2009 014 080 and WO 2013/021185.

### SUMMARY

There may be a need to enable determining of information which is indicative for a particle size and/or a particle shape of particles in a sample with a high accuracy for a wide range of samples and over an extensive size range.

There may be a need to enable determining of information which is indicative for a zeta potential of particles in a sample with a high sensitivity, also when the particle sizes are small.

The subject-matters with the features according to the independent patent claims are provided. Further embodiments are shown in the dependent claims.

According to an embodiment of the present invention, a device is provided for determining information which is indicative for a particle size and/or a particle shape of particles in a sample, wherein the device comprises an electromagnetic radiation source for generating electromagnetic primary radiation, an electromagnetic radiation detector for detecting electromagnetic secondary radiation which is generated by an interaction of the electromagnetic primary radiation with the sample, and a determination unit which is configured for determining the information (for example a particle size distribution) which is indicative for the particle size and/or the particle shape based on the detected electromagnetic secondary radiation, wherein the determination unit is adapted for selectively (wherein the selection may be performed based on a user selection or based on a selection which is dependent from the sample to be examined, for example) determining the information firstly by means of an identification and a size determination and/or a shape determination of the particles on a detector image which is generated from the electromagnetic secondary radiation, and/or determining the information secondly from temporal changes between detector images which are generated from the electromagnetic secondary radiation at different detection points in time.

According to a further embodiment of the present invention, a method is provided for determining information which is indicative for a particle size and/or a particle shape of particles in a sample, wherein in the method electromagnetic primary radiation is generated, electromagnetic secondary radiation is detected which is generated by an interaction of the electromagnetic primary radiation with the sample, and the information which is indicative for the particle size and/or particle shape is determined based on the detected electromagnetic secondary radiation, wherein the information is selectively determined firstly by means of an identification and a size determination and/or shape determination of the particles on a detector image which is generated from the electromagnetic secondary radiation, and/or the information is determined secondly from temporal changes between detector images which are generated from the electromagnetic secondary radiation at different detection points in time.

In a storage medium according to an embodiment of the present invention, a program is stored for determining information which is indicative for a particle size and/or a particle shape of particles in a sample, which program, when it is executed by one or more processors, comprises and performs, respectively, the above described method steps.

A software-program (which is formed by one or more computer program-elements, for example) according to an embodiment of the present invention for determining information which is indicative for a particle size and/or a particle shape of particles in a sample comprises the above described method steps (and executes them or controls them, respectively), when it is executed by one or more processors of the control device.

According to another embodiment of the present invention, a device is provided for determining information which is indicative for a zeta potential of particles in a sample, wherein the device comprises an electromagnetic radiation source for generating electromagnetic primary radiation, an electric field generation unit for generating an electric field in the sample, an electromagnetic radiation detector for detecting electromagnetic secondary radiation which is generated by an interaction of the electromagnetic primary radiation with the sample in the electric field, and a determination unit which is adapted for determining the information which is indicative for the zeta potential based on the detected electromagnetic secondary radiation, wherein the determination unit is adapted for determining the information which is indicative for the zeta potential from temporal changes between detector images which are generated from the electromagnetic secondary radiation at different detection points in time.

According to a further embodiment of the present invention, a method is provided for determining information which is indicative for a zeta potential of particles in a sample, wherein in the method electromagnetic primary radiation is generated, an electric field in the sample is generated, electromagnetic secondary radiation is detected which is generated by an interaction of the electromagnetic primary radiation with the sample in the electric field, and the information which is indicative for the zeta potential is determined based on the detected electromagnetic secondary radiation, wherein the information which is indicative for the zeta potential is determined from temporal changes between detector images which are generated from the electromagnetic secondary radiation at different detection points in time.

In a storage medium according to an embodiment of the present invention, a program is stored for determining information which is indicative for a zeta potential of particles in a sample, which program, when it is executed by one or more processors, comprises and performs, respectively, the above described method steps.

A software-program (which is formed by one or more computer program-elements, for example) according to an embodiment of the present invention for determining information which is indicative for a zeta potential of particles in a sample comprises the above described method steps (and executes them or controls them, respectively), when it is executed by one or more processors of the control device.

Embodiments of the present invention can be realized both by means of a computer program, i.e. a software, and by means of one or more special electrical circuits, i.e. in a hardware, or in arbitrarily hybrid form, i.e. by means of software-components and hardware-components.

According to a first embodiment of the present invention, a combination of a particle size determination and/or a particle shape determination which is synergistically implementable in a common apparatus and method performance, respectively, by means of an analysis of statistic detector images on the one hand (in particular by means of dynamic image analysis, DIA) and a respective determination by means of an analysis of density fluctuations by means of the difference image data on the other hand (in particular by means of differential dynamic microscopy, DDM) is enabled. The combination of these both complementary analysis methods enables an enlargement of the measurable size range up to smallest particles (for example up to approximately 20 nm) and therefore eliminates one of the main disadvantages of DIA compared to competition technologies (for example statistic light scattering). A size range (for example approximately 500 nm to 10 μm particle size) exists in which both, DIA and DDM can be applied. In this range, the combination of DIA with DDM delivers information which is not accessible with one of the both methods alone. According to the invention, a device is provided which is enabled to determine the information which is indicative for the particle size and/or the particle shape by means of detector image analysis, and which is enabled to determine the information by means of difference image analysis, i.e. to perform the determination of the information by means of two separate determination methods from which, in a certain application case, selectively only the one, only the other one or both may be applied.

According to a second embodiment of the present invention, a determination of the zeta potential and an electrical charge of particles, respectively, is enabled by means of an analysis of density fluctuations by means of difference image data (in particular by means of differential dynamic microscopy (DDM)). When an electric field is applied to the sample with the particles, an electrophoretic motion of the particles takes place which, by means of difference image analysis, enables to obtain information with respect to the zeta potential and the charge of the particles, respectively. The zeta-potential may denote the electric potential (also referred to as Coulomb-potential) at a moving particle in a sample (in particular a suspension). The electric potential denotes the capability of a field which is caused by an electric charge of the particle, to exert a force on other charges and charged particles, respectively.

In the following, additional exemplary embodiments of the devices, the methods, the storage media and the software-programs are described.

According to an exemplary embodiment, the determination unit may be adapted for determining the information from the detector image which is generated from the electromagnetic secondary radiation by means of dynamic image analysis (DIA). According to such an embodiment, static detector images of the particles are recorded. Each single one of these detector images (for example by methods of image processing) is then analyzed with respect to recognizing particles on the respective detector image (for example using a threshold value method using pattern recognition), and subsequently parameters (for example a particle diameter and/or a particle shape) are determined by means of the single recognized particles. When in this manner a sufficient number of detector images (for example between 100 and 10,000 detector images) with a sufficient number of respective particles (for example between 5 and 100) have been analyzed, the result can be output as particle size distribution. This method is independent from particle fluctuations, for example Brownian molecular motion.

According to an exemplary embodiment, the determination unit may be adapted for determining the information from the temporal changes between the detector images by means of differential dynamic microscopy (DDM). Differential dynamic microscopy at first creates from a multiplicity of detector images difference images on which changes of particle positions due to particle fluctuations are recognizable. These difference images may then be subjected to a Fourier-analysis. The result of the Fourier-analysis may then be averaged for the different difference images. The diffusion velocity of the particles is a function of the viscosity of the solvent of the sample, the temperature and the particle size. Information with respect to the diffusion velocity may be obtained from the result of the Fourier-analysis and, when the temperature and the solvent viscosity are known, may be used for a conclusion with respect to the particle sizes. Since the differential dynamic microscopy is not based on the identification of single particles on a detector image, by means of this methodology, also the size determination of substantially smaller particles is possible.

According to an exemplary embodiment, the determination unit may be adapted for performing the first and the second determination of the information for at least a pre-givable sub-range of particle sizes (in particular in a range between approximately 100 nm and approximately 20 μm, further in particular in a range between approximately 500 nm and approximately 10 μm). The complementarity of the particle size determination directly from single detector images on the one hand and by means of temporal difference image analysis on the other hand enables, especially in the mentioned intermediate range, finding and analyzing phenomena which are inaccessible by each single one of these methods. Thereby, an examination which is focused on the mentioned size range, or a sub-range thereof, is especially informative.

According to an exemplary embodiment, the determination unit may be adapted for performing the determination of the information for particle sizes above the pre-givable sub-range of particle sizes only by means of the first determination and/or for performing the determination of the information for particle sizes below the pre-givable sub-range of particle sizes only by means of the second determination. The particle size specific use of the first and the second determination method, respectively, in contrast to conventional devices, enables to extend the sensitivity range of determinable particle sizes. The particle recognition at detector images is limited to particle sizes which are still resolvable on the detector image and fails when particle sizes are below certain resolution limits. The particle recognition by means of difference image analysis on the contrary is lacking the required sensitivity when the particles are large, since these are moving inertly and therefore very slow, such that the particles between the different detector images often show only small differences.

According to an exemplary embodiment, the determination unit may be adapted for using the same electromagnetic radiation source and the same electromagnetic radiation detector, in particular the same beam path or at least partially the same beam path, for the first and the second determination of the information. Thereby, the device can be configured highly compact. Forming different optical paths for both determination methods and a complex adjustment of the optical path, respectively, when changing the determination method is thereby dispensable. In particular, also a beam forming optics between the electromagnetic radiation source and the sample can be provided for both determination methods in common.

According to an exemplary embodiment, the determination unit may be adapted for using at least partially the same detector data which are detected from the electromagnetic radiation detector for the first and the second determination of the information. On the one hand, this has the advantage that the results of both determination methods are directly comparable to each other and possible differences cannot result from different detector behavior in different measurements. On the other hand, this has the advantage that the amount of data which is to be processed and which is at least to be buffered is low, which guarantees low resource requirements and a short processing time. Consequently, this advantageously enables to perform a measurement in a short time which makes also dynamic phenomena accessible for the measurement.

According to an exemplary embodiment, the determination unit may be adapted for calculating and outputting a difference in the particle sizes which are determined according to the first determination and particle sizes which are determined according to the second determination. In particular when at least partially using identical detector data for both determination methods, this has the advantage that the sensitivity differences which are resulting from different physical principles of the both determination methods deliver complementary knowledge about the particles to be examined. For example, when examining particles with a hard core and a flexible or movable, less dense shell, the particle recognition can deliver a particle diameter which is determined by the core by means of detector images. In contrast, in particular recognition by difference image analysis, the size including the shell is recognized. Forming the difference between both detected particle sizes can therefore deliver the thickness of the shell.

According to an exemplary embodiment the determination unit may be adapted for performing the determination of the particle size exclusively according to the first determination above a first pregiven size threshold value, and for performing the determination of the particle size exclusively according to the second determination below a second pregiven size threshold value. Since the particle recognition by means of detector images becomes too inaccurate when the particle sizes are too small, in this order of magnitude, the particle size determination can be performed exclusively by the method of particle recognition by means of difference image analysis. Vice versa, when the particle sizes are very large, the particle size determination can be performed exclusively by the method of particle recognition directly by means of single detector images themselves, since this determination for large particles is very accurate and the large inertia of large particles in the method of particle recognition by means of difference image analysis can suffer with respect to the required accuracy.

According to an embodiment the first size threshold value and the second size threshold value may be identical, such that for each particle size only one of the both determination methods is utilized. According to an alternative embodiment the both size threshold values are different, wherein in the order of magnitude between both of the size threshold values, an evaluation with both methods can be performed.

According to an exemplary embodiment the determination unit may be adapted for performing the determination of the particle size and particle shape exclusively according to the first determination below a first pregiven concentration threshold value of the sample, and for performing the determination of the particle size exclusively according to the second determination above a second pregiven concentration threshold value of the sample (the first concentration threshold value may be smaller than or equal to the second concentration threshold value). The particle recognition by means of detector images functions well at low concentrations, since in that case, an undesired overlapping of different particles on a detector image is improbable or does not occur. However, at high concentrations, particles may overlap on the detector images, such that in that case by means of the particle recognition by means of detector images, it is not distinguishable without a doubt anymore if only one particle having a large dimension or two (or more) particles having smaller dimensions, which are located close together, are present. At high concentrations, the device can switch to the particle recognition exclusively by difference image analysis, in which no accuracy reduction occurs due to a spatial overlapping of different particles. Vice versa, if the concentration of the particles in the sample becomes too low, the method of particle size determination by means of difference image analysis reaches its limits and can then be replaced by the particle size determination by means of the direct evaluation of detector images.

According to an exemplary embodiment the determination unit may be adapted for determining information with respect to a viscosity of the sample from the first and the second determination of the information with respect to the particle sizes. From the Stokes-Einstein relation, it is possible to determine the diffusion coefficient by means of the method of particle recognition by means of detector images of determined particle sizes by means of differential dynamic microscopy, which allows for a conclusion to the viscosity of the sample when the temperature is known.

According to an exemplary embodiment the device may comprise an electric field generation unit for generating an electric field in the sample, wherein the determination unit is configured for determining information which is indicative for the zeta potential of particles in the sample based on the electromagnetic secondary radiation which is detected in the sample when the electric field is present. Furthermore, the determination unit may be adapted for additionally determining the zeta potential from temporal changes between detector images which are generated from the electromagnetic secondary radiation at different detection points in time. If an electric field in the sample is switched on, an electrophoretic motion of the sample particles begins. From this, the zeta-potential and the electric charge of the particles, respectively, can be determined when using differential dynamic microscopy.

The electromagnetic radiation source can generate light in a desired wavelength range, preferably in the range of visible light (400 nm to 800 nm). Other wavelength ranges are possible, for example infrared or ultraviolet. It is possible to configure the electromagnetic radiation source as a laser. In that case, coherent light can be generated and used for the measurement. However, in other embodiments the measurement can also be performed with non-coherent light. The latter can even be advantageous when interference artifacts shall be suppressed.

According to an exemplary embodiment the electromagnetic radiation source may be a pulsed radiation source. Using a pulsed radiation source for generating short electromagnetic radiation pulses (for example a spatially narrowly limited light package) descriptively can freeze a particle motion in the sample, such that a detector in fact can capture the apparently stationary particle on the detector image. Then, using an effect which is similar to that of stroboscopy, it can be detected with an open aperture.

According to an exemplary embodiment the device may comprise a primary beam forming optics between the electromagnetic radiation source and the sample, wherein the primary beam forming optics may be configured for collimating the electromagnetic primary radiation in parallel with respect to an optical axis. Such a collimating optics may be advantageously formed identically for the particle recognition by means of the detector images and for the particle recognition by means of the difference image analysis, which leads to a low effort with respect to the apparatus and to a direct comparability of the both determination results.

According to an exemplary embodiment the device may comprise an imaging optics between the sample and the electromagnetic radiation detector, wherein the imaging optics may be configured for imaging the electromagnetic secondary radiation on the electromagnetic radiation detector.

According to an embodiment the imaging optics may be identically utilized for the both determination methods, which leads to a compact device and to a good comparability of the both determination results.

According to an alternative embodiment the device may comprise an adjusting mechanism which is configured for adjusting the imaging optics between different optics configurations for receiving detector data for the first determination of the information and for receiving detector data for the second determination of the information. Thereby, an adjustment of the beam path can be performed in an optimized manner with respect to the respective determination method, without an entire readjustment of the beam path being required when transitioning from one of the determination methods to the respectively other one.

According to an exemplary embodiment the adjusting mechanism may be a revolver mechanism. A revolver mechanism enables, by means of rotating a revolver head in which a plurality of alternatively usable and different optical elements or optical assembly groups are implemented, to move a respectively desired optical element and a respectively desired optical assembly group, respectively, in the optical path between the sample and the electromagnetic radiation detector and thereby to select it for the use in the device. A moving mechanism which is utilizable alternatively to a revolver mechanism is a shifting mechanism which is shiftable forwardly or backwardly in a direction, in order to be able to selectively move two different optical elements or optical assembly groups in the optical path, for example.

According to an exemplary embodiment the adjusting mechanism may be configured for adjusting, for the first determination, a first imaging optics which has a smaller numerical aperture than a second imaging optics for the second determination. While in the particle recognition by means of evaluating single detector images, a small numerical aperture is advantageously, in the particle recognition by means of the difference image analysis, the resolution is higher when the numerical aperture is larger. By the adjusting mechanism, by means of a simple optical measure, for both determination methods a high accuracy in the particle size determination can be achieved.

According to an exemplary embodiment, the first imaging optics may be a telecentric optics. Such a telecentric optics may comprise two lenses (in particular two collecting lenses) and optionally an aperture which is arranged in between. Thus, for a telecentric optics also lens systems are implementable in which an aperture is dispensable.

According to an exemplary embodiment, the second imaging optics may be a microscope-objective which may be configured as a single lens, for example.

According to an exemplary embodiment, the device may comprise a sample container which is including the sample, which sample container may be arranged horizontally (liegend). Such a sample container may for example be a cuvette. A horizontal arrangement of such a sample container can be realized for example by means of a suitable optical assembly group, for example using deflecting mirrors. If the measuring cell is arranged horizontally, disturbing influences, such as particle sedimentation or forming of temperature induced flows in the measuring cell, can be suppressed or eliminated.

According to an exemplary embodiment of the invention, the information which is indicative for the particle size and/or the particle shape may comprise a particle size distribution and/or a particle shape distribution. The determination unit according to this embodiment may determine and output a distribution function which indicates the distribution of particle sizes in an ensemble of particles. Alternatively or in addition, the determination unit may determine and output a distribution function which indicates the distribution of particle shapes in an ensemble of particles.

### BRIEF DESCRIPTION OF THE DRAWINGS

In the following, exemplary embodiments of the present invention are described in detail with reference to the following figures.

FIG. 1 shows a device for determining information which is indicative for a particle size of particles in a sample and for determining a zeta-potential of the particles according to an exemplary embodiment of the invention.

FIG. 2 shows a schematic illustration for evaluating detector images by means of differential dynamic microscopy according to an exemplary embodiment of the invention.

FIG. 3 shows an image structure function for a 70 nm large PS-latex particle in water, recorded by a 10× microscope objective with a numeric aperture of 0.25, obtained by means of differential dynamic microscopy.

FIG. 4 shows a result of an evaluation according to a measurement with differential dynamic microscopy at 46, 70 and 100 nm PS-latex particles by means of the cumulants method.

FIG. 5 schematically shows the diffraction of light at a grating, wherein an angle of the first diffraction order depends on the wavelength of the incident light and the grating constant g.

FIG. 6 shows an image structure function for a 500 nm large PS-latex particle in water, recorded by means of a conventional 40× microscope objective with a numerical aperture of 0.6, obtained by means of differential dynamic microscopy.

FIG. 7 shows a device for determining information which is indicative for a particle size of particles in a sample, according to an exemplary embodiment of the invention.

FIG. 8 shows a device for determining information which is indicative for a particle size of particles in a sample, according to another exemplary embodiment of the invention, wherein a horizontal measuring cell for suppressing disturbing influences is provided, for example particle sedimentation or forming temperature-induced flows in the measuring cell.

FIG. 9 shows a schematic block diagram of a device for determining information which is indicative for a particle size of particles in a sample, according to an exemplary embodiment of the invention.

FIG. 10 shows a device for determining a zeta-potential of particles of a sample, according to an exemplary embodiment of the invention.

FIG. 11 shows a schematic block diagram of a device for determining a zeta-potential of particles of a sample, according to an exemplary embodiment of the invention.

### DETAILED DESCRIPTION OF ILLUSTRATED EMBODIMENTS

Same or similar components in different figures are provided with the same reference signs.

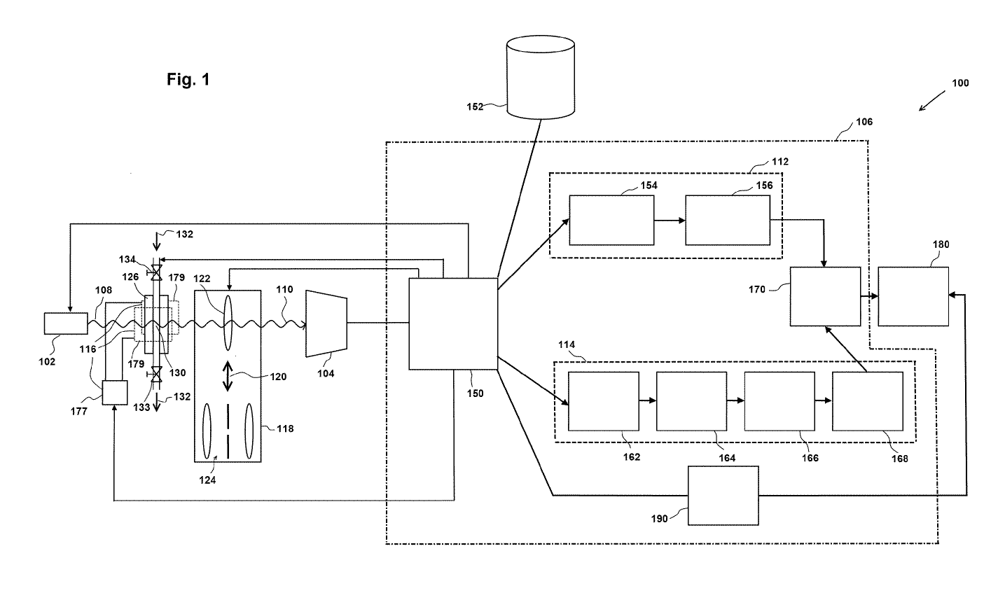

FIG. 1 shows a device 100 for determining information which is indicative for a particle size and/or a particle shape of particles in a sample 130 and for determining a zeta-potential of the particles, according to an exemplary embodiment of the invention.

The device 100 comprises an electromagnetic radiation source 102 which is configured as a pulsed laser, which is adapted for generating pulses of electromagnetic primary radiation 108 (here optical light). The electromagnetic primary radiation 108 is directed to a sample container 126. The sample 130 to be examined (for example particles which are contained in a liquid, in the order of magnitude of micrometers, for manufacturing ceramics such as titanium dioxide) flows through the sample container 126 which is configured as a flow-through cuvette in a flow direction which is indicated by arrows 132 while interacting with the electromagnetic primary radiation 108, wherein thereby the electromagnetic primary radiation 108 is converted in electromagnetic secondary radiation 110. The flow of the sample in the sample container 126 may optionally be prevented by valves 133 and 134 prior to a measurement. Furthermore, the sample container 126 may be adapted such that the flow through cuvette is replaced by any arbitrary cuvette, in order to examine sedimentation properties of the sample 130 or in order to exclude any sample change, for example. An imaging optics 118 between the sample 130 and an electromagnetic radiation detector 104 (for example a two-dimensional camera such as a CMOS-camera or a CCD-camera) is configured for imaging the electromagnetic secondary radiation 110 on the electromagnetic radiation detector 104.

The device 100 comprises a uniaxially slidable adjusting mechanism 120 (see double arrow) which is configured for adjusting the imaging optics 118 for receiving detector data for a first determination (the reference sign 112) of the information and for receiving detector data for the second determination (see reference sign 114) of the information. The adjusting mechanism 120 is configured for moving a first imaging optics 124 in the optical path between the electromagnetic primary radiation 108 and the electromagnetic secondary radiation 110 for the first determination 112, which first imaging optics 124 has a smaller numerical aperture than a second imaging optics 122 which is moved in the optical path between the electromagnetic primary radiation 108 and the electromagnetic secondary radiation 110 for the second determination 114. The first imaging optics 124 is a telecentric optics. The second imaging optics 122 is a microscope-objective. In this manner, the imaging optics 118 can be adapted with respect to the respective evaluation principle.

The electromagnetic radiation detector 104 serves for detecting the electromagnetic secondary radiation 110 in form of two-dimensional detector images which are generated by an interaction of the electromagnetic primary radiation 108 with the sample 130.

The detector data which deliver a two-dimensional image of the sample 130 are supplied to a determination unit 106 which is configured as a processor, for example, which is configured for determining the information which is indicative for the particle size based on the detected electromagnetic secondary radiation 110. More precisely, the determination unit 106 is configured for determining the information firstly (see an evaluation path which is designated with reference sign 112) by means of an identification and a size determination of the particles on multiple single detector images which are generated from the electromagnetic secondary radiation 110, and for determining the information secondly (see evaluation path which is designated with reference sign 114) from temporal changes between detector images which are generated from the electromagnetic secondary radiation 110 at different detection points in time. In other words, in the device 100, the size determination of the particles can be performed by means of a selectable procedure or by means of two complementary procedures. The determination unit 106 is adapted for determining the information from the single detector images which are generated from the electromagnetic secondary radiation 110 by means of dynamic image analysis (DIA) (see reference sign 112). The determination unit 106 is further configured for determining the information from temporal changes between the detector images by means of differential dynamic microscopy (DDM) (see reference sign 114).

The determination unit 106 in particular is adapted for performing the first (see reference sign 112) and the second (see reference sign 114) determination of the information for at least a part of a range between 100 nm and 20 μm, i.e. twice. In this range, both determination methods are sensitive and deliver information due to the complementary underlying physical principles, which information is not determinable by the respectively other determination method.

The determination unit 106 is further adapted for performing the determination of the information for particle sizes above 20 μm only by means of the first determination (see reference sign 112) and for performing the determination of the information for particle sizes below 100 nm only by means of the second determination (see reference sign 114), since the respectively other determination method in the mentioned particle size ranges is not sufficiently sensitive.

A control unit 150 receives the detector data from the electromagnetic radiation detector 104 and forwards them for further processing in one or both branches (see reference signs 112, 114). Detector data may also be stored in a database 152.

As storage medium, both computer readable storage media and/or storage media can be used which are formed by programmable logic circuits, for example field-programmable-logic-gate arrangements (FPGA), microcontrollers, digital signal processors (DSP) or the like. These storage media may be directly integrated in the device 100.

For the first determination (see reference sign 112) of the particle size distribution, i.e. the detection of particle sizes and/or particle shape directly by means of a camera image, the detector data are forwarded to a particle recognition unit 154 which, by means of methods of image processing (for example pattern recognition based on reference data), recognizes single particles on the single detector images. The identified particles are forwarded to a parameter determination unit 156 which is assigning the recognized particles to a size and/or a shape.

For the second determination (see reference sign 114) of the particle size distribution, i.e. the detection of particle sizes indirectly by generating camera difference images and deriving the particle sizes from a Fourier-analysis, the detector data at first are transferred to a difference image determination unit 162. The difference image determination unit 162 determines the respective difference images from the detector data which are recorded at different points in time. The determined difference images are subjected to a Fourier transformation in a Fourier transformation unit 164. An averaging unit 166 is averaging the results of the Fourier transformation. A parameter determination unit 168 then determines, from the results of the determination, the size distribution of the particles.

A combination unit 170 can combine the results of the both determinations according to reference signs 112 and 114. The results of the analysis may then be displayed to a user on a display unit 180.

The device 100 in addition comprises an electric field generation unit 116 for generating an electric field in the sample 130, wherein the determination unit 106 is configured for determining the zeta potential and the electric charge of the particles, respectively, of the sample 130 based on the detected electromagnetic secondary radiation 110. Controlled by means of the control unit 150, a voltage source 177 of the electric field generation unit 116 can apply an electric voltage between two opposing capacitor plates 179 of the electric field generation unit 116. The arrangement of the electrodes 179 should be positioned such that the field lines of the electric field run normal to the propagation direction of the electromagnetic primary radiation 108. In the case that the sample 130 additionally is moving in a direction which is normal to the propagation direction of the electromagnetic primary radiation 108, the electrodes 179 shall be arranged such that the field lines are aligned normal to the flow direction of the sample and normal to the propagation direction of the primary radiation.

More precisely, the determination unit 106 is configured for determining the zeta potential and the electric charge, respectively, of the particles from temporal changes between the detector images which are generated from the electromagnetic secondary radiation 110 at different detection points in time, i.e. by means of differential dynamic microscopy. For determining the zeta potential from the detector data, the latter are supplied to a zeta potential-determination unit 190 which can then forward the result of the evaluation to the display unit 180.

Dynamic image analysis (DIA) is a method which is based on the photography of moving objects. The use in the particle characterization is enabled by the development of very rapid cameras and by the combination with pulsed light sources. Rapid cameras are advantageously in order to be able to measure many particles in a short time due to reasons of statistic. A pulsed light source further enables recording very fast-moving particles without a moving blur occurring.

Differential dynamic microscopy (DDM) can be performed by means of a commercial optical microscope which illuminates the sample by means of a non-collimated white light source. The data analysis however is not based on the evaluation of the images of the particles, but on the evaluation of the temporal changes of the structures in the image. Thereby, the diffusion velocity and indirectly the size of the particles can be determined. The method is not limited by the optical limit for the resolution of a single particle.

Using non-collimated white light is possible, since in DDM not the entire scattering vector |Q| is included in the calculation, as it is usual in DLS, but only the projected scattering vector q is included in the calculation and this is independent from the incident angle and the light wavelength. The latter can be seen as an advantage of DDM with respect to DLS, since simulations have shown that for small scattering angles (<20°, corresponds to forward scattering) the difference between q and |Q| is negligible.

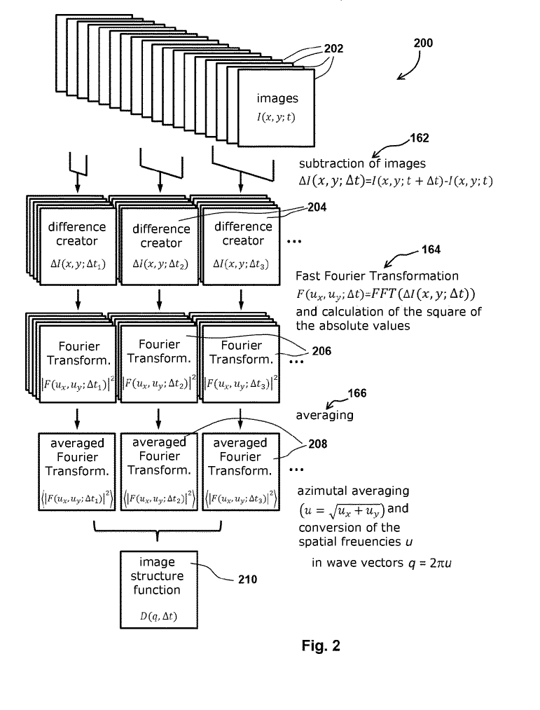

FIG. 2 shows a scheme 200 for evaluating detector images 202 by means of differential dynamic microscopy according to an exemplary embodiment of the invention. The procedure of a DDM measurement and evaluation which is described in the following is schematically illustrated in FIG. 2.

The particles in the liquid are photographed by means of an electromagnetic radiation detector 104 which is configured as a high-speed camera, i.e. intensity values I are recorded in dependency from the spatial coordinates x, y and the time t. By subtracting respectively two images (see reference sign 162) difference images 204 are generated. The time difference Δt between the detector images 202 to be subtracted is varied. Thus, a whole series of difference images 204 is obtained which contain the information about the dynamic of the system. The intensity in the difference images 204 is given by:

ΔI(x,y;Δt)=I(x,y;t+Δt)−I(x,y;t)

Subsequently, the difference images 204 are Fourier-transformed (FFT(ΔI(x,y;Δt))→F(q;Δt)), see reference sign 164, wherein thereby Fourier transforms 206 are obtained. Since the Brownian molecular motion is stochastic, the Fourier transformation delivers a rotational symmetrical image. F(q;Δt) can thus be integrated over the azimuth-angle.

After performing the Fourier transformation, an averaging is performed, see reference sign 166, wherein thereby averaged Fourier transforms 208 are obtained.

The Fourier transformation can be imagined as a decomposition of the object in refractive index gratings 500 with a different grating constant g, see FIG. 5. The relationship between the projected scattering vector (=grating vector) q and the grating constant g is given as following: q=2π/g.

The so-called Fourier performance spectrum, also referred to as image structure function 210, is given by:

D(q,Δt)=(|F(q,Δt)|²)∝g(q,Δt)

wherein g(q,Δt) is the intensity-autocorrelation function as it is also known from the DLS theory.

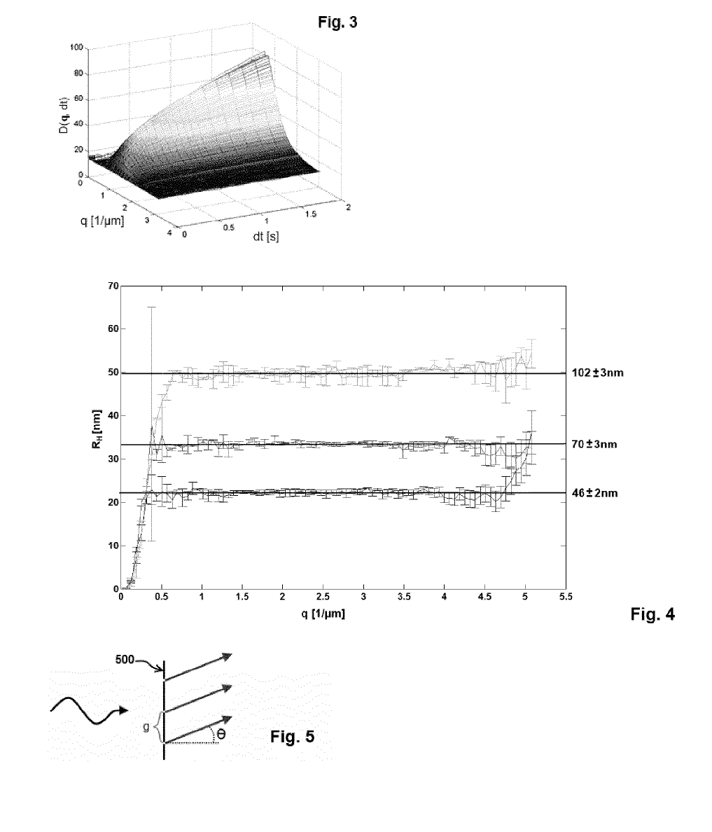

FIG. 3 shows D(q,Δt) for 70 nm PS (polystyrene) latex particles in water, recorded by a 10× microscope objective.

Thus, from D(q,Δt) for example by means of the cumulants-method (see Koppel, Dennis E. (1972), “Analysis of Macromolecular Polydispersity in Intensity Correlation Spectroscopy: The Method of Cumulants”, The Journal of Chemical Physics 57 (11): 4814), the particle size can be calculated: FIG. 4 shows a result of an evaluation according to a measurement with differential dynamic microscopy at 46 nm, 70 nm and 100 nm PS-latex particles by means of the cumulants-method.

Due to a DDM measurement, measuring data at different q-vectors are already present. The result thus corresponds to a multiplicity of single DLS experiments which were performed at these q-vectors (=scattering angles).

Conventional methods for determining particle sizes have disadvantages which can be overcome by the inventive measuring principle:

The measuring range of the dynamic image analysis (DIA) is limited towards below by the optical resolution limit. This constitutes a significant disadvantage compared to competing technologies, for example static light scattering (SLS).

Polydisperse samples which contain particles below the optical resolution limit, cannot be entirely characterized a means of DIA. The small proportions of the size distribution function get lost.

The particle concentration in DIA is limited due to the condition that overlappings of particles on the recorded images are highly improbable. It is not possible to distinguish random overlappings of the particles from aggregates. The limit for the particle concentration which is still measurable depends on the used imaging optics, the used detector and the particle size itself.

By means of dynamic image analysis (DIA), only that parts of the particles can be recognized which have a significant difference in the refractive index with respect to the solvent. For example, strongly swollen polymer shells (steric stabilization) remain invisible.

DIA delivers a static image of the particles. Dynamic processes, for example a diffusion motion or an electrophoretic motion are not accessible.

In order to at least partially overcome these disadvantages, exemplary embodiments of the invention have been developed:

In the context of the present invention, it has been figured out that DIA and DDM almost have identical requirements concerning the measuring geometry and can thus be implemented in the same device. Also the periphery which is required for the operation of the measuring device is highly similar.

By a combination of the technologies, the measuring range with respect to the particle size can be significantly enlarged. While DIA is limited with respect to small particle sizes by the optical resolution limit (smallest particles which are still measurable should be at least ca. 100 nm large), DDM is able to measure far below (for example up to ca. 20 nm). With respect to large particles, DDM is limited by the diffusion motion which, with increasing particle size, becomes slower and thus more difficult to measure. The upper measuring limit for DDM is ca. 10 μm particle size. The reason for this limitation can be explained as following. Until a particle having a size of, for example, 10 μm diffuses a distance which is detectable by means of optical imaging, in fact multiple seconds may pass. When the measuring times are such long, it becomes difficult to exclude disturbing influences, for example sedimentation or vibrations.

By the relatively large overlapping in the measuring range between DIA and DDM (for example ca. 500 nm up to 10 μm), the following advantages result:

While in DIA an image of the particle is directly evaluated, DDM is an indirect method in which the diffusion velocity is determined from an image. For ideal dispersions of diluted smooth spheres it is expected that the both determined diameters are matching. If, in experiment, discrepancies between the both results occur, this can be interpreted as effect of a deviation from this ideal behavior. Therefore, from the combination of both methods, valuable information about non-ideal behavior can be obtained. In the following, a concrete example is described:

In examination by means of DIA and DDM, sterically stabilized particles can lead to different results. The optical contrast of the swollen polymer shell this extremely low compared to the contrast of the particle core. Correspondingly, DIA delivers the core diameter as a result. For DDM, the situation is fundamentally different. The diffusion behavior is determined by the thermal energy and the flow resistance. The effective diameter in this case is the core diameter plus twice the thickness of the shell.

Since the shell is moving with the particle, the shell effectively decelerates the diffusion. From the combination of DIA and DDM, the thickness of the polymer shell is experimentally accessible (R_{DDM}-R_{DIA}). Neither DIA nor DDM can deliver this information on their own.

In real samples, compositions with very different particle sizes are often present. Many methods for particle size determination cannot determine the correct distribution of particle sizes from such compositions. For example, dynamic light scattering DLS is disturbed by low concentrations of large particles (for example aggregates or dust). Then it is no longer possible to determine the particle size of nano-particles, also when they are present in a substantially higher concentration. A substantial advantage of DDM with respect to DLS is that there is not such a strong sensitivity with respect to large contaminants in low concentration. In the course of data evaluation, in DDM respectively two images which are recorded at different points in time are subtracted from each other. Very large particles only move extremely slow and thus disappear from the difference image. The contribution of the small particles which diffuse rapidly and therefore have significantly moved in the time between the both records is not influenced by the large particles. Thus, DDM allows measuring small particles besides very large particles. For DIA, nano-particles indeed are outside of the measuring range. However, large particles are recognizable very well. By the combination of DIA and DDM, a complete characterization of samples with nano-particles and low amounts of large particles results. This would not be possible with one method alone.

For DIA, it shall be ensured that the particles in the image are not overlaying each other. This can be achieved by a respective dilution. The size determination in samples with high concentrations of particles is problematic. How high the concentration of the particles is exactly allowed to be depends on the selected imaging optics, the detector and the particle size. In contrast, DDM operates well at high concentrations and reaches its limits at low particle densities. The limitation towards high concentrations is determined by the condition of the quasi-ideal dilution in the Stokes-Einstein-equation. The combination of both technologies thus enlarges the concentration range in which it is able to measure correctly.

Usually, the Stokes-Einstein-relation is used for calculating the particle radius R from the diffusion coefficient D (with a given viscosity η of the solvent, the Boltzmann constant k_{B} and the absolute temperature T):

$$R = \frac{{k}_{B} T}{6 π η D}$$

The method of micro rheology however uses the Stokes-Einstein relation in another form. It determines the viscosity η of the solvent from the diffusion coefficient:

$$η = \frac{{k}_{B} T}{6 π R D}$$

However, for this purpose it is necessary to add particles with a known size and thus to possibly change the sample. By the combination of DIA and DDM it is possible to directly determine all required input parameters. While the particle size can be directly taken from the images (DIA), the diffusion coefficient can be determined via DDM. The precondition is only that particles (of unknown size) are present in the overlapping range of DIA and DDM.

FIG. 7 shows a device 100 for determining information which is indicative for a particle size of particles in a sample 130, according to an exemplary embodiment of the invention.

In order to be able to eliminate the above mentioned disadvantages of the DIA technology by means of a combination with DDM, the technology combination can be used which is shown in FIG. 7.

The measuring arrangements for performing DIA and DDM are very similar, both technologies can commonly use a majority of the components of the device 100, or even the entire components. The measuring arrangement in form of the device 100 consists of a light source as electromagnetic radiation source 102 which sends a light beam as electromagnetic primary radiation 108 along an optical axis 702, a beam forming optics 700, a measuring cell as sample container 126 which contains the sample 130 to be examined, an imaging optics 118 and an image sensor as electromagnetic radiation detector 104. The inlet window and the outlet window, respectively, of the measuring cell are designated with the reference signs 704 and 706, respectively. The beam forming optics 700 serves for a beam expansion and collimation, respectively, in order to cause a sharp image. It can be taken from FIG. 7 that the optical path length which is required for the electromagnetic primary radiation 108 passing the sample container 126 is very short, in order to avoid falsifications of the size determination of particles which are located in close proximity to the inlet window 704 and the outlet window 706, respectively. It can be further taken from FIG. 7 that the imaging optics 118 is formed by two collecting lenses 708 between which an aperture 710 is arranged (alternatively, also an aperture-less lens system is possible). The imaging optics 118 can be adapted such that it maintains the image at the position of the electromagnetic radiation detector 104 permanently equally large.

With regard to the light source which is most suitable, DIA and DDM have practically identical requirements. Both technologies also operate with coherent and polychromatic light. However, for suppressing disturbing interference artifacts in the images, an incoherent or only very weakly coherent light source is preferred. Since usually there is no reason for recording DIA images in color, also using a monochromatic light source is fully sufficient in many cases. Actually, monochromatic light has many advantages. For example imaging errors which are caused by chromatic aberration can be avoided and the relation between the projected scattering vector q and the actual scattering vector |Q| is then distinct (except of an angle dependency). With regard to a good adjustability of the optical setup with a high resolution capability at the same time, a wavelength is preferred which is as short as possible but which is still within the spectral range which is visible for the human eye. Also using a pulsed light source, as usual for DIA, does not constitute a problem for DDM and actually is an advantage, respectively, since also in DDM only snapshots have to be made.

A further improvement with regard to the quality of the recorded images is achieved in DIA by using a collimated illumination. The beam forming optics 700 thus is aligning the light beams which are coming from the electromagnetic radiation source 102 in parallel with respect to the optical axis 702. This manner of illumination is also an advantage for DDM. Since there are no more light beams which obliquely impinge the object, the relation between the projected scattering vector q and the actual scattering vector |Q| is distinct (except of a wavelength dependency).

Differences with regard to the requirements of the setup of DIA and DDM devices are most notably present in the imaging optics 118. Since DIA is a method in which particles are directly measured by means of the images, perspective falsifications as they occur in conventional entocentric (and also pericentric) optics shall be avoided, if possible. Thus, particles shall appear equally large independent from their distance to the imaging optics 118. Although DIA is also possible with conventional optics, therefore often so-called telecentric optics are used for imaging the particles on the detector. However, exactly these telecentric optics often have a low numerical aperture NA (especially when it is a bi-telecentric image) which constitutes a limitation for DDM with respect to the accessible q-range and the resolution. DDM-comparison measurements with three different objectives (40× microscope objective with NA=0.6, 10× microscope objective with NA=0.25, 8× telecentric objective with NA=0.09) have shown that the 10× microscope objective is most suitable due to its optical parameters (magnification, NA and light intensity).

The reason for this can be imagined again with the decomposition of the object in periodic refractive index gratings 500. The NA of an optics limits the optics with respect to the angle under which a light beam can still enter the optics and contributes to the optical image. FIG. 5 schematically shows the diffraction of light at a refractive index grating 500, wherein the angle of the first diffraction order is dependent from the wavelength of the incident light and the grating constant g. Since each grating scatters the incident light, depending on the grating constant, to a certain angle Θ (see FIG. 5; only the first diffraction order is regarded here), the NA also constitutes a limitation in the grating vectors g which can still be received and, due to q=2π/g, also in the projected scattering vectors q. If it is desired to cover a scattering vector range which is as large as possible by means of DDM, using an imaging optics with high numerical aperture is suggested.

However, whereby is the q-range shown in FIG. 3 and its resolution in a typical DDM measurement further determined? In order to be able to clarify that, the magnification M (with M>1 for a magnifying image and M<1 for a reducing image) of the imaging optics, the size of the pixel array-detector (assumption: square with m pixels side length) and the size of the pixels located thereon (square with an edge length S_{P}) have to be known. Under the assumption that the imaging optics is matched to the pixel array-detector, in other words the pixel array-detector is illuminated by the optics over the entire diagonal, the field of view F at the side of the object, which can be still imaged by the imaging optics on the detector, is resulting to:

$$F = \frac{m \cdot {S}_{p}}{M} , F = {F}_{m} \cdot {F}_{m}$$

Since the q-vector is given by q=2π/g, and the smallest possible grating in the image has to comprise a grating constant of two pixels, qₘₐₓ is given by

$${q}_{max} = \frac{2 π \cdot M}{2 {S}_{p}} = \frac{π \cdot M}{{S}_{p}} .$$

For FIG. 3, with a pixel-edge length of 14 μm this results to: qₘₐₓ=2.24 μm⁻¹. However, qₘₐₓ in FIG. 3 is slightly larger than 3. The discrepancy results from the diagonal of the Fourier-transformed image, which diagonal is larger than the width and the height, respectively, by the factor \sqrt{2}. Thereby, the correct value results: q*ₘₐₓ=qₘₐₓ \sqrt{2}=3.17 μm⁻¹. Measuring data concerning q-values which are larger than qₘₐₓ should not be used for evaluating, since they do not contain useful information about the image. The smallest possible q-value now results to:

$${q}_{min} = \frac{{q}_{max}}{m} = \frac{π \cdot M}{{S}_{p \cdot m}} = 2.8 {e}^{- 3} {µm}^{- 1}$$

at an image width of m=800 pixels.

From the previous considerations, the following can be concluded:

The usable q-vector range in the context of the here described theory is limited towards above by the NA of the objective. That is, the scattering vector can be maximum so large that the first diffraction order of the corresponding grating can still be recorded by means of the optics.

$${q}_{upper \text{-} limit} = \frac{2 π \cdot NA}{N \cdot λ} = / for N = 1 /= \frac{2 π \cdot NA}{λ}$$

$$( N … diffraction order ) .$$

The usable q-vector range in the context of the here described theory is also limited towards above by the magnification of the imaging optics and the pixel size of the used detector

$${q}_{max} = \frac{π \cdot M}{{S}_{p}} .$$

The last issue shows that an optics with a larger magnification makes a larger q-range accessible. However, it is also to be considered that the used optics is able to resolve the effective pixel size

$${S}_{p \text{-} eff} = \frac{{S}_{p}}{M}$$

and can transfer such small structures with a sufficient contrast as well. This can be read from the modulation transfer function of the optics.

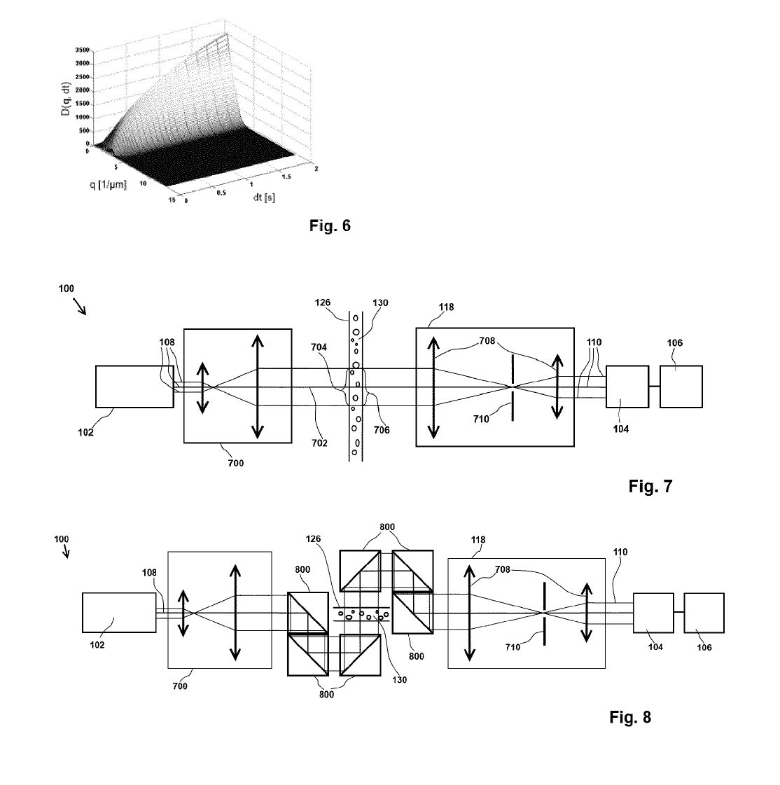

For the example of FIG. 3 with NA=0.25 and λ=430 nm, restriction 1 would deliver a crupper-limit=3.653 μm⁻¹ and restriction 2 would deliver a qₘₐₓ=2.244 μm⁻¹. Thus, the NA of the optics would not be the limitation in this case, since the q-range is already stronger limited by the selected magnification and the size of the detector pixels. However, it is to be considered that a large q-range is not always advantageously, since not at all q-values useful data are measured. The optics and the detector should be selected such that only one q-range is recorded, if possible, in which the measuring data are useful. FIG. 6 shows an example for this. FIG. 6 shows an image structure function for a 500 nm large PS-latex particle in water, recorded by a conventional 40× microscope objective with a numerical aperture of 0.6, obtained by means of differential dynamic microscopy.

The recorded q-range is in fact large due to the strongly magnifying objective, but useful measuring data are only present for a small q-range (for this measurement is qₘₐₓ=8.98 μm⁻¹).

With respect to the measuring method DDM, in the following additional considerations shall be described:

Smaller particles are moving faster compared to larger particles, thus they lead to a significant difference signal in the DDM difference images. The mean distance s which a particle was moving away from an initial point in a certain time T can be expressed as the root of the mean square displacement (MSD): \sqrt{MSD}={square root over ((s²(τ)))}=\sqrt{2Dτ}. Thus, in order to be able to measure larger particles by means of DDM, very small displacements should be measured.

When regarding sections along the dt-axis (these curves are proportional to the intensity correlation function) in FIG. 3, it can be noted that these curves for certain q-values, when the difference times dt (dt corresponds to the above mentioned distance time Δt which has passed between two subtracted images) are large, are transitioning in a plateau. This plateau means that each correlation between the single images which were used for the difference image has been lost. Only when the curves are transitioning in a plateau, the characteristic decay time T and in the following the particle size can be calculated from them. The q-dependency of the decay time is known from dynamic light scattering and is given by: τ=1/(Dₘq²), with Dₘ being the mass diffusion coefficient of the particles. It should also be paid attention that the measuring duration and thus also the decay time Δt which is maximum available for the difference images is adapted to the particle size (for larger particles it should be measured longer).

Particles in the Rayleigh limit constitute so-called phase objects, therefore they are less scattering in the forward direction compared to larger particles. With decreasing particle size, the influence of the particles on the difference images decreases and at any time it gets so low that it disappears in the detector noise and thus cannot be evaluated anymore. The amplitude of the image structure function D(q,Δt) for small q-values is proportional to q⁴.

FIG. 8 shows a device 100 for determining information which is indicative for a particle size of particles in a sample 130, according to another exemplary embodiment of the invention, wherein a horizontal sample container 126 and a horizontal measuring cell, respectively, for suppressing disturbing influences, for example particle sedimentation or forming temperature induced flows in the measuring cell, is provided. The horizontal orientation of the sample container 126 is enabled by an arrangement of deflecting mirrors 800.

Since the particles for a size determination by means of DDM are allowed to be subjected only to the Brownian molecular motion, for large particles it can be an advantage to configure the measuring cell and the sample container 126, respectively, horizontal as shown in FIG. 8, for example. The influence of sedimentation and also the generation of undesired flows by temperature gradients (as they can be caused by a laser, for example) is reduced in this manner.

In the following, considerations with respect to a DDM measurement in and of laminar flows are explained.

If the diffusion motion is superimposed with a directed laminar flow, the particle size determination by means of DDM is possible as well. However, the rotational symmetry of the Fourier-transformed difference images ΔI(q,Δt) is broken and integrating over the azimuth-angle is therefore not allowed anymore. Only data which result from a motion perpendicular with respect to the laminar flow shall be used for the DDM evaluation. A majority of the recorded measuring data thus cannot be used for the evaluation and the signal-to-noise ratio is correspondingly worse and more measuring data should then be recorded, respectively.

DDM cannot only be used for determining the particle size, but also for measuring the flow velocity of a suspension, for example. The flow which is superimposed to the Brownian motion leads to a strip pattern in the image structure function which can be evaluated with respect to the strip distance and in this manner the flow velocity can be determined. Since the cause which is generating the flow is not decisive for the flow measurement, for example also the electrophoretic mobility can be measured by this method. From the electrophoretic mobility of particles, then also the zeta potential of the particles can be calculated. By means of DDM it is also possible to measure both particle size and zeta potential.

Usually, for DIA multiple telecentric objectives are used, in order to cover a sufficiently large measuring range. Small particles should be magnified (typically 10-15×), in order to be still recognizable on the pixel-array detector, whereas very large particles even have to be optionally imaged in a reduced manner (typically by the factor two). In order to make a reproducible exchange between different optics as comfortable as possible, for example an optics revolver can be placed at the location of the imaging optics 118 which is shown in FIG. 7 and FIG. 8. Exchanging the different optics can be performed manually or automatically.

As already mentioned, not using a telecentric optics, but a conventional microscope objective with high NA may be an advantage for DDM. This may also be mounted in the optics revolver.

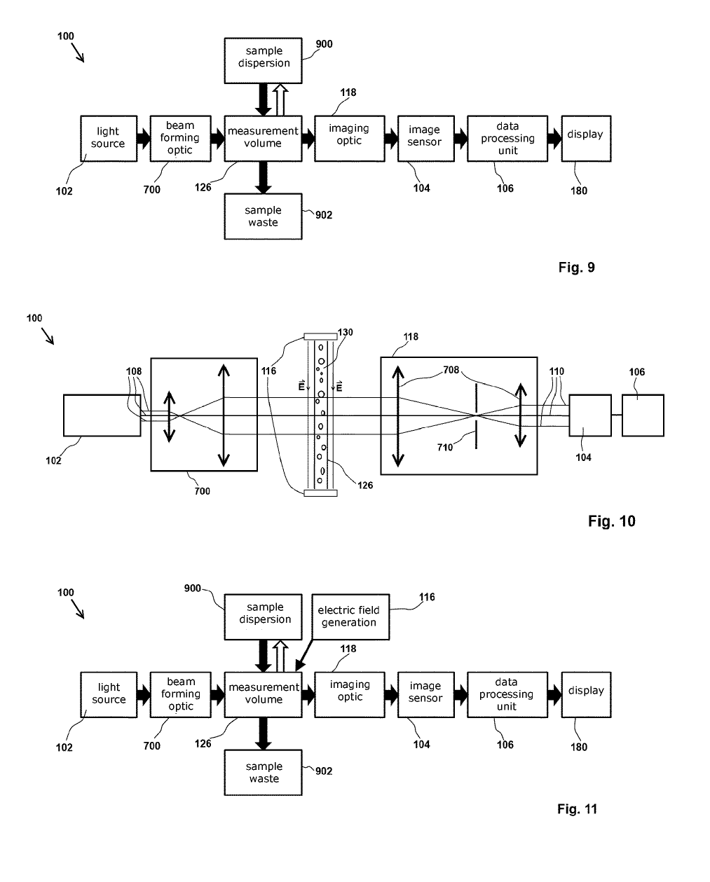

FIG. 9 shows a schematic principle arrangement of a device 100 for determining information which is indicative for a particle size of particles in a sample, according to an exemplary embodiment of the invention.

Complementary to FIG. 7 and FIG. 8, for the operation of the combination device, also a display unit 180 and a provision for sample dispersion and for discharging sample waste is advantageously. For the sample preparation and disposal, optionally a sample dispersion unit 900 and a sample waste unit 902 can be embedded in the device 100.

FIG. 10 shows a device 100 for determining a zeta potential and an electric charge state, respectively, of particles of a sample 130, according to an exemplary embodiment of the invention.

The device 100 according to FIG. 10 differs from the device according to FIG. 7 substantially in that an electric field generation unit 116 for generating an electric field in the sample 130 is provided, and in that the determination unit 106 is exclusively adapted for determining the zeta potential of the particles in the sample 130 by means of differential dynamic microscopy (DDM). In contrast, the determination unit 106 is not necessarily adapted for evaluating the detector data which are captured by the electromagnetic radiation detector by means of dynamic image analysis. For the remaining components, reference is made to the miscellaneous description in the context of this patent application.

The device 100 according to FIG. 10 comprises an electromagnetic radiation source 102 for generating electromagnetic primary radiation 108. The device 100 further includes the electric field generation unit 116 for generating an electric field in the sample 130. An electromagnetic radiation detector 104 serves for detecting electromagnetic secondary radiation 110 which is generated by an interaction of the electromagnetic primary radiation 108 with the sample in the electric field. The determination unit 106 is configured for determining the zeta potential based on the detected electromagnetic secondary radiation 110. More precisely, the determination unit 106 is adapted for determining the zeta potential from temporal changes between detector images which are generated from the electromagnetic secondary radiation 110 at different detection points in time, i.e. by means of differential dynamic microscopy.

FIG. 11 shows a schematic principle arrangement which is corresponding to FIG. 10, of a device 100 for determining a zeta-potential of the particles, according to an exemplary embodiment of the invention, with a field generation unit 116. With respect to the additional components, reference is made to the above description of FIG. 9.

Complementary, it should be noted that “comprising” does not exclude any other elements or steps and “a” or “an” does not exclude a multiplicity. It should further be noted that features or steps which are described with reference to one of the above embodiments can be also used in combination with features or steps of other above described embodiments. Reference signs in the claims are not construed as limitation.

1. Device for determining information which is indicative for a particle size and/or a particle shape of particles in a sample, wherein the device comprises:
an electromagnetic radiation source for generating electromagnetic primary radiation;
an electromagnetic radiation detector for detecting electromagnetic secondary radiation which is generated by an interaction of the electromagnetic primary radiation with the sample; and
a determination unit which is adapted for determining the information which is indicative for the particle size and/or the particle shape based on the detected electromagnetic secondary radiation;
wherein the determination unit is adapted for
selectively determining the information firstly by means of an identification and a size determination and/or a shape determination of the particles on a detector image which is generated from the electromagnetic secondary radiation, and/or
for determining the information secondly from temporal changes of the electromagnetic secondary radiation between detector images which are generated at different detection points in time.

2. Device according to claim 1, further comprising at least one of the following features:
wherein the determination unit is adapted for determining the information from the detector image which is generated from the electromagnetic secondary radiation by dynamic image analysis, and
wherein the determination unit is adapted for determining the information from temporal changes between the detector images by differential dynamic microscopy.

3. (canceled)

4. Device according to claim 1, wherein the determination unit is adapted for performing both the first and the second determination of the information for at least one pre-givable sub-range of particle sizes in a range between 100 nm and 20 μm.

5. Device according to claim 4, wherein the determination unit is adapted for performing the determination of the information for particle sizes above the pre-given sub-range of particle sizes only by the first determination and/or for performing the determination of the information for particle sizes below the pre-givable sub-range of particle sizes only by the second determination.

6. Device according to claim 1, further comprising at least one of the following features:
wherein the determination unit is adapted for using the same electromagnetic radiation source and/or the same electromagnetic radiation detector for the first and the second determination of the information,
wherein the determination unit is adapted for using at least partially the same detector data which are detected by the electromagnetic radiation detector for the first and the second determination of the information, and
wherein the determination unit is adapted for calculating and outputting a difference between particle sizes which are determined according to the first determination and particle sizes which are determined according to the second determination.

7.-8. (canceled)

9. Device according to claim 1, wherein the determination unit is adapted for performing the determination of the particle size exclusively according to the first determination above a first pre-givable size threshold value and for performing the determination of the particle size exclusively according to the second determination below a second pre-givable size threshold value, wherein the first size threshold value is larger than or equal to the second size threshold value.

10. Device according to claim 1, further comprising at least one of the following features:
wherein the determination unit is adapted for performing the determination of the particle size exclusively according to the first determination below a first pregiven concentration threshold value of the sample and for performing the determination of the particle size exclusively according to the second determination above a second pregiven concentration threshold value of the sample, wherein the first concentration threshold value is smaller than or equal to the second concentration threshold value, and
wherein the determination unit is adapted for determining information with respect to a viscosity of the sample from the first and from the second determination of the information with respect to the particle size.

11. (canceled)

12. Device according to claim 1, further comprising:
an electric field generation unit for generating an electric field in the sample; and
wherein the determination unit is adapted for determining the information which is indicative for the zeta potential of particles in the sample based on the electromagnetic secondary radiation which is detected in the sample when the electric field is present.

13. Device according to claim 12, further comprising at least one of the following features:
wherein the determination unit is adapted for determining the information which is indicative for the zeta potential from temporal changes between detector images which are generated from the electromagnetic secondary radiation at different detection points in time by differential dynamic microscopy,
wherein the electromagnetic radiation source is adapted for emitting the electromagnetic primary radiation in a pulsed manner, and
wherein the device further comprises a primary beam forming optics between the electromagnetic radiation source and the sample, wherein the primary beam forming optics is adapted for collimating the electromagnetic primary radiation in parallel with respect to an optical axis.

14.-15. (canceled)

16. Device according to claim 1, further comprising:
an imaging optics between the sample and the electromagnetic radiation detector, wherein the imaging optics is adapted for imaging the electromagnetic secondary radiation on the electromagnetic radiation detector.

17. Device according to claim 16, further comprising:
an adjusting mechanism which is adapted for adjusting the imaging optics between different optics configurations for receiving detector data for the first determination of the information and for receiving detector data for the second determination of the information.

18. Device according to claim 17, wherein the adjusting mechanism is a revolver mechanism.

19. Device according to claim 17 or 18, wherein the adjusting mechanism is adapted for adjusting a first imaging optics for the first determination, which first imaging optics has a smaller numerical aperture than a respective aperture of the second imaging optics for the second determination.

20. Device according to claim 19, wherein the first imaging optics comprises or consists of a telecentric optics.

21. Device according to claim 19 or 20, wherein the second imaging optics comprises or consists of a microscope-objective.

22. Device according to claim 1, further comprising:
a sample container which is accommodating the sample and arranged to intersect incident electromagnetic radiation generated by the electromagnetic radiation source.

23. Device according to claim 1, wherein the determined information which is indicative for the particle size and/or the particle shape comprises a particle size distribution and/or a particle shape distribution.

24. Method of determining information which is indicative for a particle size and/or a particle shape of particles in a sample, wherein the method comprises:
generating electromagnetic primary radiation;
detecting electromagnetic secondary radiation which is generated by an interaction of the electromagnetic primary radiation with the sample; and
determining the information which is indicative for the particle size and/or the particle shape based on the detected electromagnetic secondary radiation wherein the information is selectively determined firstly by an identification and a size determination and/or a shape determination of the particles on a detector image which is generated by the electromagnetic secondary radiation and/or the information is determined secondly from temporal changes of the electromagnetic secondary radiation between detector images which are generated at different detection points in time.

25. A non-transitory computer readable storage medium, in which a program is stored for determining information which is indicative for a particle size and/or a particle shape of particles in a sample, which program, when it is executed by a processor, is performing or controlling the following steps:
directing an electromagnetic radiation source to generate electromagnetic primary radiation that is emitted in a direction to interact with a sample;
detecting electromagnetic secondary radiation which is generated by an interaction of the electromagnetic primary radiation with the sample; and
using an acquisition device to determine information indicative of a characteristic of a particle size based on the electromagnetic secondary radiation;
wherein the information is selectively determined firstly by particles on a detector image which is responsive to the electromagnetic secondary radiation, and/or secondly from temporal changes between detector images which are generated at different times.

26. (canceled)

27. Device for determining information which is indicative for a zeta potential of particles in a sample, wherein the device comprises:
an electromagnetic radiation source for generating electromagnetic primary radiation;
an electric field generation unit for generating an electric field in the sample;
an electromagnetic radiation detector for detecting electromagnetic secondary radiation which is generated by an interaction of the electromagnetic primary radiation with the sample in the electric field; and
a determination unit which is adapted for determining the information which is indicative for the zeta potential based on the detected electromagnetic secondary radiation;
wherein the determination unit is adapted for determining the information which is indicative for the zeta potential from temporal changes of the electromagnetic secondary radiation between detector images which are generated at different detection points in time.

28. Device according to claim 27, comprising at least one of the following features:
wherein the determination unit is adapted for determining the information which is indicative for the zeta potential by differential dynamic microscopy,
wherein the electromagnetic radiation source is adapted for emitting the electromagnetic primary radiation in a pulsed manner,
wherein the device comprises,
a primary beam forming optics between the electromagnetic radiation source and the sample, wherein the primary beam forming optics is adapted for collimating the electromagnetic primary radiation in parallel with respect to an optical axis, and
an imaging optics between the sample and the electromagnetic radiation detector, wherein the imaging optics is adapted for imaging the electromagnetic secondary radiation on the electromagnetic radiation detector.

29.-31. (canceled)

32. Method for determining information which is indicative for a zeta potential of particles in a sample, the method comprising:
generating electromagnetic primary radiation;
generating an electric field in the sample;
detecting electromagnetic secondary radiation which is generated by an interaction of the electromagnetic primary radiation with the sample in the electric field; and
determining the information which is indicative for the zeta potential based on the detected electromagnetic secondary radiation;
wherein the information which is indicative for the zeta potential is determined from temporal changes of the electromagnetic secondary radiation between detector images which are generated at different detection points in time.

33.-34. (canceled)
